(19) United States
(12) Patent Application Publication
(10) Pub. No.: US 2009/0269726 A1
(43) Pub. Date: Oct. 29, 2009

(54) Method of teaching emergent readers

(76) Inventor: Karyn Loaiza, Naperville, IL (US)

Correspondence Address: Karyn Loaiza, 2532 Oneida Lane, Naperville, IL, 60563, US

(21) Appl. No.: 12/288,189

(22) Filed: Oct. 17, 2008

Related U.S. Application Data
(60) Provisional application No. 60/999,460, filed on Oct. 18, 2007.

(51) Int. Cl. G09B 17/00

(52) U.S. Cl. 434/178

(57) ABSTRACT

A method and apparatus are provided for teaching emergent readers. The method includes the steps of associating a first color of with all short vowel combinations;

associating a second color with all long vowel combinations where the second color is different than the first color and color coding text displayed to the emergent reader with short vowel combinations displayed in the first color and long vowel combinations displayed in the second color.

### FIELD OF THE INVENTION

The field of the invention relates to education and more particularly to methods of teaching reading.

### BACKGROUND OF THE INVENTION

The ability to read is fundamental to education. However, reading is not the same as having a command of English or some other language. Reading differs because it requires that the reader be able to translate between written letters and phonemes.

Teaching a child (or adult) to read requires a number of different processes. On a first level, the reader must be taught to recognize the various characters of the alphabet and the general sounds that may be associated with each letter of the alphabet. Once the alphabet has been mastered, the reader must also be taught the changes in sound associated with certain combinations of letters.

Once the reader learns the general sounds of the alphabet, the reader must then master the concept of vowels. The reader must learn the differences between soft vowels and hard vowels and the conditions that require the use of a hard vowel over a soft vowel.

In order to truly understand the contents of text, the reader may need to learn the concepts and meanings of root words. Prefixes and suffixes must also be mastered to understand the changes in meaning to root words caused by the use of prefixes and suffixes.

In order to accelerate the progress of learning reading, many educators promote the use of lists of most commonly used words (e.g., Fry's sight list). In this case, the educator may focus on the most commonly used words. The educator may focus on similar words as a means of teaching young readers how to differentiate between similar words and the impact of different letter combination on the meaning of each word within the list.

While such methods are effective, they still rely upon memory as the primary mechanism of learning. Such methods are slow, confusing and frustrating. Accordingly a need exists for better methods of learning the concepts of reading.

### SUMMARY

A method and apparatus are provided for teaching emergent readers. The method includes the steps of associating a first color of with all short vowel combinations; associating a second color with all long vowel combinations where the second color is different than the first color and color coding text displayed to the emergent reader with short vowel combinations displayed in the first color and long vowel combinations displayed in the second color.

### BRIEF DESCRIPTION OF THE DRAWINGS

FIG. 1 is a block diagram of a reading education system in accordance with an illustrated embodiment of the invention;

FIG. 2 is a plain-text screen that may be displayed to a user of the system of FIG. 1;

FIG. 3 is a colorized and syllabically divided text screen that may be displayed to a user of the system of FIG. 1; and

FIG. 4 is a black and white syllabically divided text screen that may be displayed to a user of the system of FIG. 1.

### DETAILED DESCRIPTION OF AN ILLUSTRATED EMBODIMENT

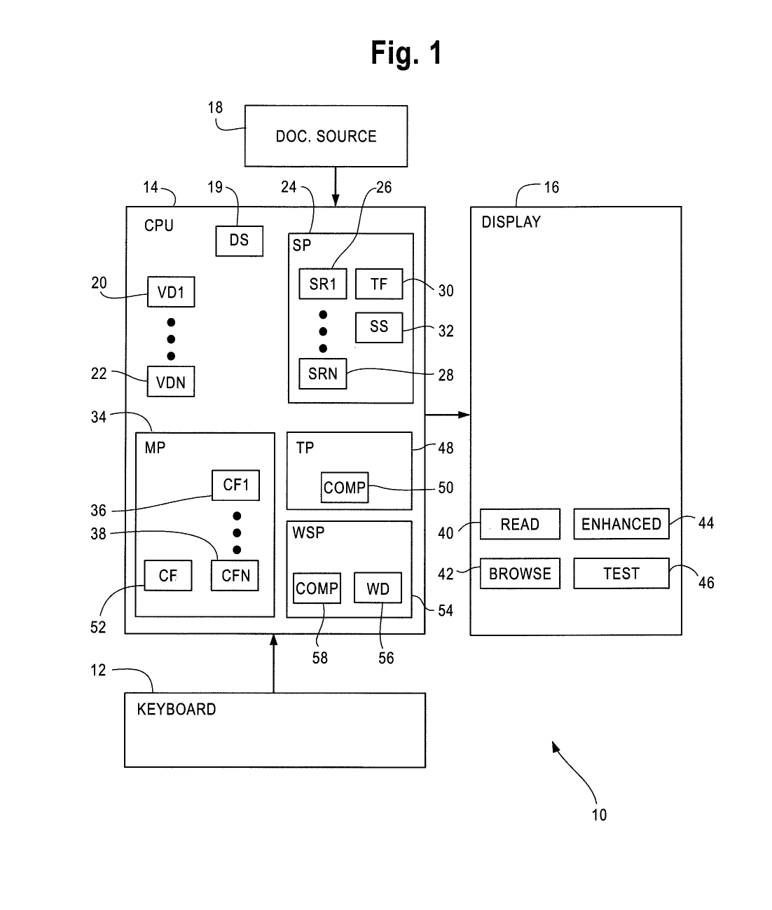

FIG. 1 is a block diagram of a reading education system 10 shown generally under an illustrated embodiment of the invention. The reading education system 10 includes a keyboard 12, a central processing unit (CPU) 14 and a display 16. The system 10 may also include an internal source of documents 19.

The system 10 may operate as a stand-alone system or may import documents from other sources (e.g., the Internet, books on line, etc.) 18. In all cases, the system 10 operates to process the text to first divide the text into a set of syllables and then to color code the syllables based upon a set of pronunciation rules for each syllable. In effect, the color coding using in conjunction with the displayed letters of the syllables define a set of phonemes for each syllable.

As a first step, the system 10 may operate to teach an emergent reader to associate a set of phonemes with an set of one or more color coded letters displayed using a set of vertical prompting screens 20, 22 equivalent to a flip chart where each combination of letter(s) has one color to represent the classification and phoneme(s) that should be produced where that letter combination is encountered.

For example, a first color (e.g., red) may be used for short vowel combinations, a second color (e.g., blue) for long vowel combinations, a third color (e.g., purple) for consonant/vowel blends, a fourth color (e.g., green) for diphthongs. Within the vertical displays, consonants are black because they never change. In effect, the color codes teach a reader how to associate phonemes with letter combinations.

Color may also be used to highlight words with which the emergent reader may already be familiar. For example, yellow may be used to identify sight words (from Fry's Instant List).

Table I depicts a prompting screen 20, 22 that may be shown on the display 16 for short or soft vowels. When shown within text, short vowels may be coded red.

TABLE I

| | | | | |
|---|---|---|---|---|
| a | e | i | o | u |
| | ea | ui | | ou |

(short when alone except ea, ui and ou).

Similarly, Table II depicts a screen 20, 22 for long or hard vowel sounds. Long vowels may be coded blue when shown in the context of a text display.

TABLE II

| a | e | I | u | o |
|---|---|---|---|---|
| ai | Ee | I e | u e | o e |
| ay | ea | igh | ue | oa |
| eigh | ey | y | ew | ow |
| a e | ei | Ie | eu | ough |
| ey | ie | | | |
| | e e | | | |
| | y | | | |

Table III depicts an additional screen 20, 22 for long vowels that need consonants and that would be coded with a blue color.

TABLE III

| | | |
|---|---|---|
| ild | ind | old |
| oll | olt | |

Table VI depict a screen 20, 22 for initial blends. In this case, an initial blend means a prefix of consonants that change the pronunciation of later verbs. Blends may be coded with the color purple.

TABLE VI

| | | | |
|---|---|---|---|
| bl | cl | fl | gl |
| sw | tw | pl | sl |
| sm | sn | sp | st |
| sk | br | cr | dr |
| fr | gr | pr | tr |
| wh | ch | th | sh |
| ci | ti | thr | shr |
| scr | spr | spl | |

Table V depicts a screen of final blends. A final blend is a series of consonants that change the pronunciation of a preceding vowel. Final blends may also be coded with the color purple.

TABLE V

| | | | | | |
|---|---|---|---|---|---|
| ck | sk | if | ft | lt | nt |
| ip | mp | st | ng | nd | nk |
| ch | tch | th | sh | | |

Table VI depicts the screen 20, 22 of final blends involving the consonant “r” with various vowels that change the pronunciation to what will be referred to as a “bossy r” where the number of “Rs” shown are in indication of the hardness of the pronunciation of the “R.”

TABLE VI

| | | | | |
|---|---|---|---|---|
| ar-R | er-R-R-R | ir-R-R-R | ur-R-R-R | or-or |

Table VII depicts the screen 20, 22 of diphthongs. Diphthongs may be coded with the color green.

TABLE VII

| | | | | | |
|---|---|---|---|---|---|
| ow, ou | oi, oy | all | oo | le | au, aw |

In order to depict text 30 for a user, a syllable processor 24 operating under a set of syllable rules 26, 28 may first divide each word into one or more syllables. As text is received by the syllable processor 24, the syllable processor 24 may divide the words in accordance with the following rules. For example, a first rule 26, 28 may require that each syllable has only one vowel sound (e.g., “cat”). A second rule 26, 28 may requires that the number of vowel sounds in a word equals the number of syllables (e.g., the word “subject” would be divided into “sub-ject”, where the dash indicates the division of syllables). A third rule 26, 28 may be that a one syllable word is never divided (e.g., feet). A fourth rule 26, 28 may require that consonant blends and digraphs are never separated (e.g., bush-el). A fifth rule 26, 28 may require that when a word has a ck or an x in it, the word is usually divided after the ck or x (e.g., nick-el). A sixth rule 26, 28 may require that a compound words be divided between the two words that make the compound word (e.g., foot-ball). A seventh rule 26, 28 may require that when two or more consonants come between two vowels in one word it is usually divided between the first two consonants (e.g., but-ter). An eighth rule 26, 28 may require that when a single consonant comes between two vowels in a word, it is usually divided after the consonant where the vowel is short (e.g., cab-in). A ninth rule 26, 28 may require that when a single consonant comes between two vowels in a word, it is usually divided before the consonant if the vowel is long (e.g., fe-ver). A tenth rule 26, 28 may require that when two vowels comes together in a word, and are sounded separately, divide the word between the two vowels (e.g., ra-di-o). An eleventh rule 26, 28 may require that when a vowel is sounded alone in a word, it forms a syllable itself (e.g., grad-u-ate). A twelveth rule 26, 28 may require a word that has a prefix to be divided between the root word and the prefix (e.g., dis-count). A thirteenth rule 26, 28 may require that when be, de, ex and re are at the beginning of a word, they make a syllable of their own (e.g., be-came). A fourteenth rule may require a word that has a suffix to be divided between the root word and the suffix (e.g., kind-ness). A fifteenth rule 26, 28 may require that when a word ends in le, preceded by a consonant, the word is divided before that consonant (e.g., pur-ple). A sixteenth rule 26, 28 may require that when “ed” comes at the end of a word, it forms a syllable only when preceded by d or t. A seventeenth rule 26, 28 may require that when a word or syllable ends in al or el, these letters usually form the last syllable (e.g., lev-el). An eighteenth rule 26, 28 may require that when “ture” and “tion” are at the end of a word, they make their own syllable (e.g., lo-tion). A nineteenth rule 26, 28 may require that where a word is divided between syllables at the end of a line, the hyphen (-) stays with the syllable at the end of the line.

By applying the above rules, the syllable processor 24 may divide the text file 30 into a syllable string file 32. The syllable string file 32 may be transferred to a marking processor 34.

Within the marking processor 34 may be a number of classification files 36, 38 that incorporate the classifications shown in Tables I-VII. The classification files 36, 38 may be look-up tables or may incorporate a more sophisticated algorithm for identifying and classifying the letters and letter combinations of each syllable returned by the syllable processor 24.

The marking processor 34 may retrieve the syllable string file 32 and compare each syllable of the file 32 with the classification files 36, 38 and associate the appropriate color to each letter or series of letters within a syllable that meets the appropriate classification. The syllable string and colors associated with each syllable may be saved in a color file 52.

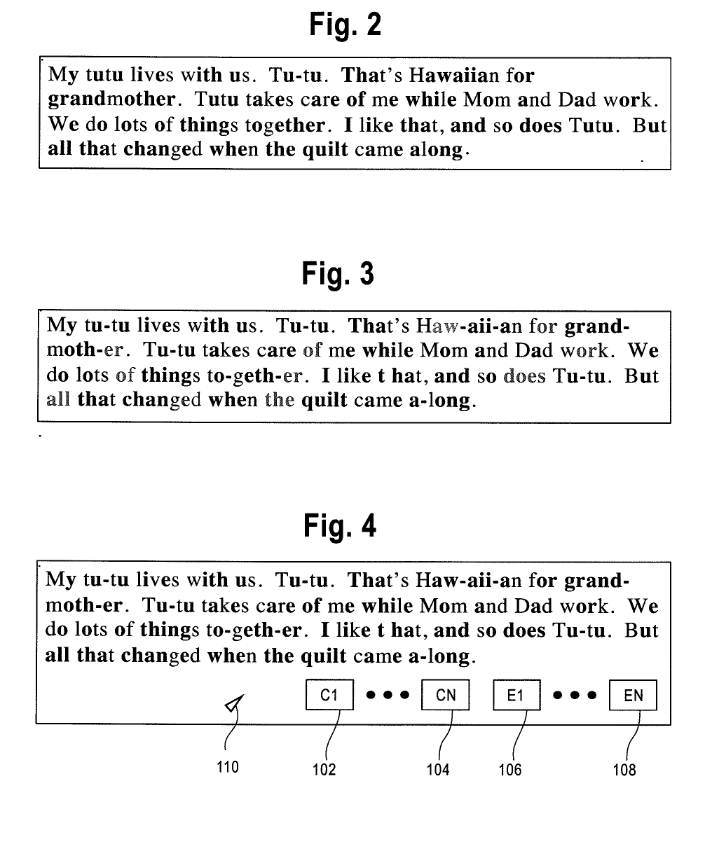

FIG. 2 shows an example of a text string that may be saved in a text file 30. FIG. 3 illustrates syllable string file 32 after the appropriate coloring of the letters. For example, the letter “y” in “My” is shown colored blue to illustrate a long vowel combination. This is shown in Table II, third column, forth row through the entry “_y.” The letter “i” in “live” is a short vowel combination and is colored red because the letter “i” is shown in Table I and doesn't meet any of the other conditions shown in Table II.

FIG. 3 helps an emergent reader sound out the pronunciation of words. The colors help the reader understand the context of the letter combination in a way that is not available using prior methods. When a reader becomes stuck on a word, the reader may go back and find other words that the reader may be more familiar with and that may help the reader understand the pronunciation of a current word.

The reader may use the system 10 in any of a number of different modes. For example, from the screen 16, the user may activate a read softkey 40 and then a browse softkey 42 to identify text that the user may want to read. The user may browse for and select an appropriate text file 30. In response, the screen of FIG. 2 may be displayed for the benefit of the reader.

Upon the display of the text, the user may proceed to read the text. If the user should have difficulty reading the text, then the user may activate the softkey labeled ENHANCED 44 and be presented with the colored text of FIG. 3. The colored and syllabically divided text may help the user understand and further develop the user's reading skill.

In still another mode, the user may choose to test his reading skills. In this case, the user may activate the TEST softkey 46 to activate a test processor 48 of FIG. 1. In this case, test processor 48 may present the screen of FIG. 4 to the user. As shown, the syllabic divisions are still shown, but the color coding is missing. In this case, the user may test his/her own knowledge of how the letters of the test should be colored as described above.

To test the user's skills, a set of color keys 102, 104 and a set of corresponding error display windows 106, 108 are provided. In this case, the color key 102 may be colored red to indicate short vowel and the error window 106 may also be highlighted in red to indicate how may wrong (or correct) selections may be the user.

The user may first select a color by using a cursor 110 to activating one of the color softkeys (e.g., the red softkey 102). In response, the red selection softkey 102 and red error detection window 106 may begin flashing. The user may then place the cursor 110 over any letter within the text and activate an associated mouse switch.

Once the user activates the softkey 102, the test processor 48 tracks the position of the cursor 110 and compares a current position of the cursor 110 with the screen position of each letter within the colorized text file 52. When the test processor 48 detects activation of the mouse switch, a comparator 50 within the test processor 48 compares the color of the selection softkey 102 with a color of the letter stored within the file 52. If the comparator 50 indicates a match, then the test processor 48 causes the selected letter to begin flashing with the correct color. If the comparator 50 does not indicate a match, then the selected letter does not change color. Instead the error window 106 is incremented to indicate that the user has made an incorrect selection.

In another embodiment, a word search processor 54 may also monitor the cursor 110 for selection of prefixes, suffixes and root words identified (as described above) by the syllable processor 24. In this case, when the word search processor 54 detects selection of a prefix, suffix or root word, the word search processor 54 may use a comparator 58 to compare the selected prefix, suffix or root word with entries within a word dictionary. When a match is found, the definition of the selected prefix, suffix or root word is presented on the display 16 for the benefit of the user.

A specific embodiment of method and apparatus for teaching emergent readers has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of teaching emergent readers comprising:
associating a first color of with all short vowel combinations;
associating a second color with all long vowel combinations where the second color is different than the first color; and
displaying color coding text to the emergent reader with short vowel combinations displayed in the first color and long vowel combinations displayed in the second color.

2. The method of teaching emergent readers as in claim 1 further comprising displaying blends in a third color where the third color is different than the first and second colors and where a blend is a predetermined combination of consonants and at least one vowel.

3. The method of teaching emergent readers as in claim 2 further comprising displaying diphthongs in a fourth color where the fourth color is different than any of colors one through three.

4. The method of teaching emergent readers as in claim 3 further comprising displaying all sight words in a fifth color wherein the fifth color is different than any of colors one through four.

5. The method of teaching emergent readers as in claim 1 further comprising displaying a definition of any prefixes selected from within the text.

6. The method of teaching emergent readers as in claim 1 further comprising displaying a definition of any suffixes selected within the text.

7. The method of teaching emergent readers as in claim 1 further comprising displaying a definition of any root words selected within the text.

8. The method of teaching emergent readers as in claim 1 wherein the step of displaying the color coding further comprises receiving a proposed color for a combination from a user before displaying the associated color code of the combination.

9. The method of teaching emergent readers as in claim 8 counting any errors of color proposed by the user.

10. A apparatus for teaching emergent readers comprising:
a first color associated with all short vowel combinations;
a second color associated with all long vowel combinations where the second color is different than the first color; and
color coding text displayed to the emergent reader with short vowel combinations displayed in the first color and long vowel combinations displayed in the second color.

11. The apparatus for teaching emergent readers as in claim 10 further comprising blends displayed in a third color where the third color is different than the first and second colors and where a blend is a predetermined combination of consonants and at least one vowel.

12. The apparatus for teaching emergent readers as in claim 11 further comprising diphthongs displayed in a fourth color where the fourth color is different than any of colors one through three.

13. The apparatus for teaching emergent readers as in claim 12 further comprising sight words displayed in a fifth color wherein the fifth color is different than any of colors one through four.

14. The apparatus for teaching emergent readers as in claim 10 further comprising a word selection processor that displays definitions of prefixes, suffixes or root words selected in the displayed text.

15. An apparatus for teaching emergent readers comprising:
associating a first color of with all short vowel combinations;
associating a second color with all long vowel combinations where the second color is different than the first color; and
displaying color coding text to the emergent reader with short vowel combinations displayed in the first color and long vowel combinations displayed in the second color.

16. The apparatus for teaching emergent readers as in claim 15 further comprising means for displaying blends in a third color where the third color is different than the first and second colors and where a blend is a predetermined combination of consonants and at least one vowel.

17. The apparatus for teaching emergent readers as in claim 16 further comprising means for displaying diphthongs in a fourth color where the fourth color is different than any of colors one through three.

18. The apparatus for teaching emergent readers as in claim 18 further comprising means for displaying all sight words in a fifth color wherein the fifth color is different than any of colors one through four.

19. The apparatus for teaching emergent readers as in claim 15 further comprising means for displaying a definition of any prefixes selected from within the text.

20. The apparatus for teaching emergent readers as in claim 15 further comprising means for displaying a definition of any suffixes selected within the text.

21. The apparatus for teaching emergent readers as in claim 15 further comprising means for displaying a definition of any root words selected within the text.

22. The apparatus for teaching emergent readers as in claim 15 wherein the means for displaying the color coding further comprises means for receiving a proposed color for a combination from a user before displaying the associated color code of the combination.

23. The method of teaching emergent readers as in claim 22 means for counting any errors of color proposed by the user.
